(19) United States
(12) Patent Application Publication
(10) Pub. No.: US 2026/0093842 A1
(43) Pub. Date: Apr. 2, 2026

(54) VEHICLE CONTROL SYSTEM, ARBITRATION METHOD, AND STORAGE MEDIUM STORING PROGRAM

(71) Applicant: DENSO CORPORATION, Kariya-city (JP)

(72) Inventor: Yusuke KANI, Kariya-city (JP)

(21) Appl. No.: 19/412,747

(22) Filed: Dec. 8, 2025

Related U.S. Application Data
(63) Continuation of application No. PCT/JP2024/021709, filed on Jun. 14, 2024.

(30) Foreign Application Priority Data
Jun. 15, 2023 (JP) 2023-098559

(51) Int. Cl. G06F 21/62

(52) U.S. Cl. CPC G06F 21/6218

(57) ABSTRACT

A vehicle control system is configured to provide, in response to a request from application software, restriction information set for each usage pattern classified according to use or purpose of utilizing an HMI for a vehicle, the restriction information including an HMI available in the usage pattern and constraints imposed on the HMI in the usage pattern, to application software that is a source of the request, and to control the HMI in accordance with an HMI usage request from the application software requesting use of the HMI. The vehicle control system is configured to determine to which usage pattern a content of the HMI usage request corresponds, and, when HMI usage requests conflict, to arbitrate conflicting HMI usage requests according to a priority associated with each usage pattern.

### CROSS REFERENCE TO RELATED APPLICATION

The present application is a continuation application of International Patent Application No. PCT/JP2024/021709 filed on Jun. 14, 2024 which designated the U.S. and claims the benefit of priority from Japanese Patent Application No. 2023-098559 filed on Jun. 15, 2023. The entire disclosures of all of the above applications are incorporated herein by reference.

### TECHNICAL FIELD

The present disclosure relates to a technology for arbitrating usage requests for Human Machine Interfaces (HMI) installed in a vehicle.

### BACKGROUND

A vehicle is equipped with multiple application software, and each application software utilizes the Human Machine Interface (hereinafter referred to as in-vehicle HMI) installed in the vehicle for notification to the user.

For example, a related art describes a technology for arbitrating HMI usage requests from multiple application software in accordance with a preconfigured priority table that stipulates the priority relationship among services.

### SUMMARY

According to an aspect of the present disclosure, a vehicle control system includes at least one of (i) a circuit and (ii) a processor with a memory storing computer program code executable by the processor. The at least one of the circuit and the processor is configured to cause the vehicle control system to: provide, in response to a request from application software, restriction information set for each usage pattern classified according to use or purpose of utilizing an HMI for a vehicle, the restriction information including an HMI available in the usage pattern and constraints imposed on the HMI in the usage pattern, to application software that is a source of the request; and control the HMI in accordance with an HMI usage request from the application software requesting use of the HMI. The at least one of the circuit and the processor may determine to which usage pattern a content of the HMI usage request corresponds, and, when HMI usage requests conflict, may arbitrate conflicting HMI usage requests according to a priority associated with each usage pattern.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the configuration of the vehicle control system;

FIG. 2 is a block diagram showing the configuration of the ECU;

FIG. 3 is a block diagram showing the configuration of the center;

FIG. 4 is a block diagram showing the functional configuration of the vehicle control system;

FIG. 5 is an explanatory diagram illustrating the contents of HMI information; FIG. 6 is an explanatory diagram showing the arrangement and other aspects of visual usage HMI;

FIG. 7 is an explanatory diagram illustrating the contents of restriction information;

FIG. 8 is a flowchart of HMI arbitration processing;

FIG. 9 is a sequence diagram showing the standard processing flow during HMI information requests and HMI usage requests;

FIG. 10 is a sequence diagram exemplifying the processing flow when a conflict of HMI usage requests occurs and the subsequent request wins the arbitration;

FIG. 11 is a sequence diagram exemplifying the processing flow when a conflict of HMI usage requests occurs and the subsequent request wins the arbitration or has the same priority as the preceding request;

FIG. 12 is a sequence diagram exemplifying the processing flow when a conflict of HMI usage requests occurs and the subsequent request loses the arbitration or has the same priority as the preceding request; and

FIG. 13 is a sequence diagram exemplifying the processing flow when a conflict of HMI usage requests occurs and the subsequent request loses the arbitration.

### DETAILED DESCRIPTION

As a result of detailed investigation by the inventors, it has been found that conventional technology using a priority table may not be able to determine the priority of HMI usage requests from updated or newly added application software.

That is, the existing priority table does not possess information regarding updated application software. Therefore, when using a priority table, it has been necessary to perform the cumbersome and extensive task of rewriting the priority table each time the application software is updated.

One aspect of the present disclosure provides a technology that facilitates arbitration of HMI usage requests from added application software.

One aspect of the present disclosure is a vehicle control system including an information providing unit and an output control unit. The information providing unit is configured to provide, in response to a request from application software, restriction information set for each usage pattern classified according to use or purpose of utilizing an HMI for a vehicle, the restriction information including the HMI available in the usage pattern and constraints imposed on the HMI in the usage pattern. The output control unit is configured to control the HMI in accordance with an HMI usage request from the application software requesting use of the HMI. The output control unit is configured to determine to which usage pattern a content of the HMI usage request corresponds, and, when HMI usage requests conflict, to arbitrate the conflicting HMI usage requests according to a priority associated with each usage pattern.

According to such a configuration, it is possible to easily realize arbitration of HMI usage requests from added application software.

One aspect of the present disclosure is an arbitration method for arbitrating HMI usage requests in which a computer installed in a vehicle arbitrates HMI usage requests from a plurality of application software utilizing HMI for the vehicle. In the arbitration method, the computer determines which usage pattern, classified according to use or purpose of utilizing the HMI, a content of the HMI usage request corresponds to. Furthermore, when the HMI usage requests conflict, the computer arbitrates the conflicting HMI usage requests according to a priority associated with each usage pattern.

According to such a method, the same effects as the above described vehicle control system can be obtained.

An embodiment of the present disclosure is a program for causing a computer to function as the above described information providing unit and information output unit. According to such a program, the same effects as the above described vehicle control system can be obtained.

Hereinafter, embodiments of the present disclosure will be described with reference to the drawings.

### 1. System Configuration

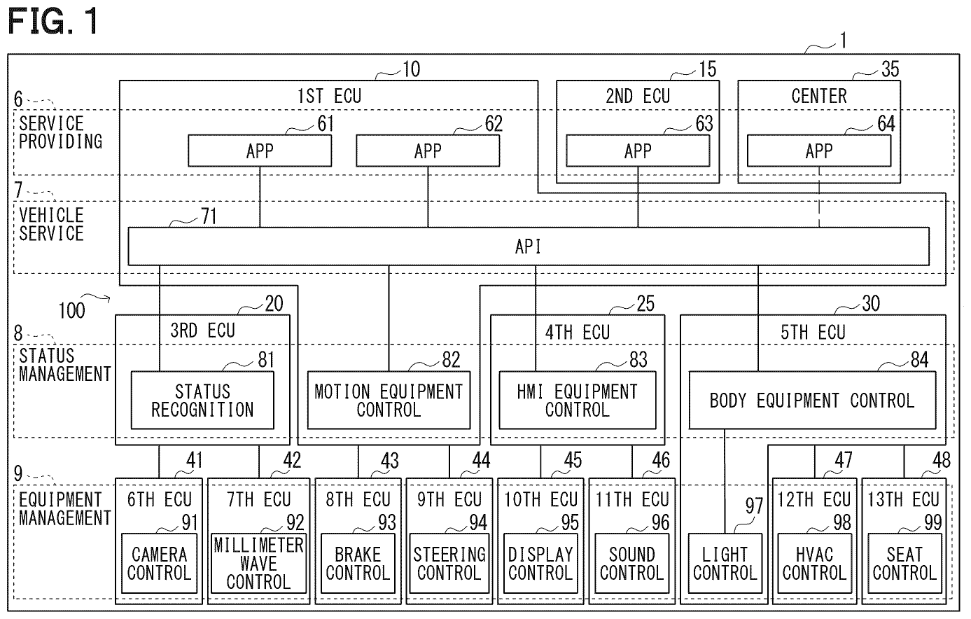

The vehicle control system 1 shown in FIG. 1 includes an electronic control unit group (hereinafter, ECU group) 100 installed in a vehicle such as an automobile, and a center 35. The ECU group 100 includes a plurality of ECUs. In the present embodiment, the ECU group 100 includes a first ECU 10, a second ECU 15, a third ECU 20, a fourth ECU 25, a fifth ECU 30, and sixth to thirteenth ECUs 41 to 48. Each ECU belonging to the ECU group 100 is connected to each other via in-vehicle communication (i.e., wired or wireless communication). The center 35 is provided outside the vehicle and is connected to the ECU group 100 via external communication (i.e., wireless communication).

The first ECU 10 has a relay function for in-vehicle communication and supervises the second to fifth ECUs 15 to 30, thereby realizing coordinated control of the entire vehicle. Furthermore, the first ECU 10 also supervises communication with the center 35, thereby realizing coordinated control of the entire system including the center 35.

The first ECU 10 and the third to fifth ECUs 20 to 30 are provided for each domain classified according to functions in the vehicle, and mainly execute control of multiple ECUs (i.e., any of the sixth to thirteenth ECUs 41 to 48) existing within the respective domain. The domains include, for example, powertrain, body, chassis, and cockpit.

The sixth to thirteenth ECUs 41 to 48 control vehicle equipment, which are devices installed in the vehicle.

Vehicle equipment may include hardware such as sensors and actuators, various storage devices for storing data, and software for realizing certain functions.

The first ECU 10 and the third to fifth ECUs 20 to 30 are connected to the subordinate sixth to thirteenth ECUs 41 to 48 via individually provided lower-level networks (for example, CAN). CAN stands for Controller Area Network and is a registered trademark. The first ECU 10 and the third to fifth ECUs 20 to 30 have functions for centrally managing access rights to the subordinate sixth to thirteenth ECUs 41 to 48 and performing user authentication, etc.

In another embodiment, the vehicle control system 1 may include the ECU group 100, and the center 35 may be omitted. In another embodiment, the number of ECUs belonging to the ECU group 100 may be 14 or more, or 13 or fewer. In another embodiment, a plurality of centers 35 may be provided.

### 2. Hardware Configuration

Next, the hardware configuration of each ECU belonging to the ECU group 100 and the center 35 will be described. Each ECU belonging to the ECU group 100 has a similar hardware configuration. Therefore, the configuration of the first ECU 10 will be described as a representative example.

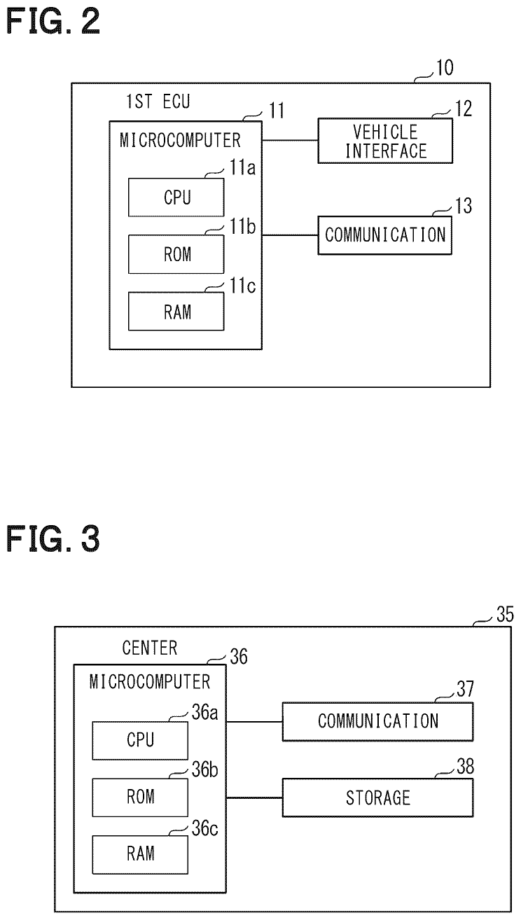

As shown in FIG. 2, the first ECU 10 includes a microcomputer 11, a vehicle interface (hereinafter, I/F) 12, and a communication unit 13. The microcomputer 11 includes a CPU 11a, a ROM 11b, and a RAM 11c. Various functions of the first ECU 10 are realized by the CPU 11a executing a program stored in a non-transitory tangible recording medium. In the present embodiment, the ROM 11b corresponds to the non-transitory tangible recording medium storing the program. Further, by executing this program, a method corresponding to the program is executed.

The vehicle I/F 12 connects to other ECUs and in-vehicle devices via the in-vehicle network and acquires various information from other ECUs and in-vehicle devices. The in-vehicle network may include CAN and Ethernet. Ethernet is a registered trademark.

The communication unit 13 performs data communication with the center 35 and the like via a wide-area communication network using wireless communication. However, it is not necessary for all ECUs belonging to the ECU group 100 to be equipped with the communication unit 13. Only one or some of the ECUs may be equipped with it.

The methods for realizing the various functions provided by the first ECU 10 are not limited to software, and some or all elements may be realized using one or more hardware components. For example, when the above functions are realized by electronic circuits as hardware, such electronic circuits may be digital circuits including a large number of logic circuits, analog circuits, or a combination of digital and analog circuits.

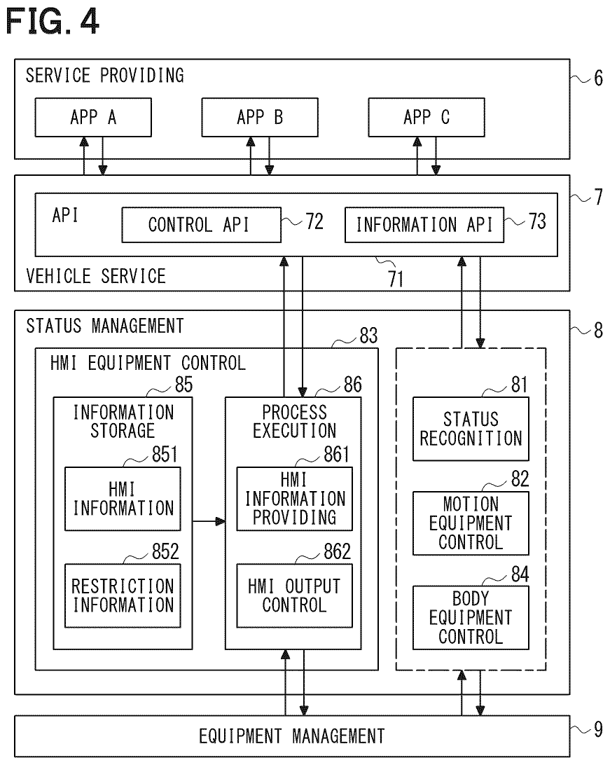

As shown in FIG. 3, the center 35 includes a microcomputer 36, a communication unit 37, and a storage unit 38. The microcomputer 36 includes a CPU 36a, a ROM 36b, and a RAM 36c. Various functions of the center 35 are realized by the CPU 36a executing a program stored in a non-transitory tangible recording medium. In the present embodiment, the ROM 36b corresponds to the non-transitory tangible recording medium storing the program. Further, by executing this program, a method corresponding to the program is executed.

The communication unit 37 performs data communication with the ECU group 100 via a wide-area communication network. The storage unit 38 is a storage device for storing vehicle data and the like provided by the ECU group 100.

The methods for realizing the various functions provided by the center 35 are not limited to software, and some or all elements may be realized using one or more hardware components. For example, when the above functions are realized by electronic circuits as hardware, such electronic circuits may be digital circuits including a large number of logic circuits, analog circuits, or a combination of digital and analog circuits.

### 3. Functional Configuration

Returning to FIG. 1, the various functions provided by the vehicle control system 1 will be described. The software architecture of the vehicle control system 1 is structured into four layers. Specifically, the vehicle control system 1 includes the functions of an equipment management unit 9 in the first layer, a state management unit 8 in the second layer, a vehicle service unit 7 in the third layer, and a service providing unit 6 in the fourth layer. The functions provided by the vehicle control system 1 are distributed among the ECUs belonging to the ECU group 100 and the center 35.

### (3-1. Equipment Management Unit)

The equipment management unit 9 includes a plurality of control units 91 to 99 corresponding to various types of vehicle equipment. Vehicle equipment includes, for example, in-vehicle cameras, in-vehicle millimeter wave radar, brakes, steering, displays, speakers, various lights, in-vehicle air conditioner, and electric power seats.

Specifically, the equipment management unit 9 includes a camera control unit 91, a millimeter wave control unit 92, a brake control unit 93, a steering control unit 94, a display control unit 95, a sound control unit 96, a light control unit 97, a Heating Ventilation and Air-Conditioning (hereinafter, HVAC) control unit 98, and a seat control unit 99. Each vehicle equipment is individually controlled by the corresponding control unit among control units 91 to 99.

The camera control unit 91 controls the exposure and other functions of the in-vehicle camera to acquire captured images from the in-vehicle camera. In the present embodiment, the sixth ECU 41 is provided with the camera control unit 91.

The millimeter wave control unit 92 controls the in-vehicle millimeter wave radar and acquires detection results detected by the millimeter wave radar. In the present embodiment, the seventh ECU 42 is provided with the millimeter wave control unit 92.

The brake control unit 93 controls the brakes. In the present embodiment, the eighth ECU 43 is provided with the brake control unit 93.

The steering control unit 94 controls the steering. In the present embodiment, the ninth ECU 44 is provided with the steering control unit 94.

The display control unit 95 controls displays (for example, meters, warning lamps, etc.). In the present embodiment, the tenth ECU 45 is provided with the display control unit 95.

The sound control unit 96 controls the speakers to output sounds such as warning sounds and voice from the speakers. In the present embodiment, the eleventh ECU 46 is provided with the sound control unit 96.

The light control unit 97 controls various lights installed in the vehicle. In the present embodiment, the fifth ECU 30 is provided with the light control unit 97.

The HVAC control unit 98 controls the in-vehicle air conditioner. In the present embodiment, the twelfth ECU 47 is provided with the HVAC control unit 98.

The seat control unit 99 controls the electric power seat of the vehicle. In the present embodiment, the thirteenth ECU 48 is provided with the seat control unit 99.

The equipment management unit 9 operates the vehicle equipment in accordance with operation instructions from the state management unit 8 and notifies the state management unit 8 of the operation results. For example, if the vehicle equipment is an actuator, the operation result may indicate that the actuator has completed normally or abnormally. If the vehicle equipment is a sensor, the operation result may indicate data detected by the sensor. If the vehicle equipment is a storage device, the result notification may indicate data read from the storage device.

In addition to operating vehicle equipment in accordance with operation instructions from the state management unit 8, the equipment management unit 9 may also be configured to autonomously detect the state of vehicle equipment and notify the state management unit 8.

### (3-2. Service Providing Unit)

The service providing unit 6 realizes various functions, such as information collection, theft prevention, and remote operation, by executing application software (hereinafter, applications) 61 to 64 and utilizing vehicle equipment managed by the equipment management unit 9.

In the present embodiment, the first ECU 10, the second ECU 15, and the center 35 are provided with the service providing unit 6. The ROM 11b of the first ECU 10 stores applications 61 and 62. The ROM 11b of the second ECU 15 stores application 63. The ROM 36b of the center 35 stores application 64.

Applications 61 to 64 are basically configured to realize the intended service by utilizing the functions of vehicle equipment via the API unit 71, which constitutes the vehicle service unit 7.

Applications 61 to 64 are not dedicated programs for executing processing adapted to specific vehicle models or specific grades, but are general-purpose programs for executing processing adapted to many vehicle models and grades. Therefore, applications 61 to 64 are described using generally published, modeled vehicle functions so that they can be created without regard to the vehicle equipment or performance possessed by individual vehicles. In other words, applications 61 to 64 can be easily developed by third parties who are application providers other than vehicle manufacturers or suppliers, and the developed products can be widely published. Accordingly, the vehicle user, who is the owner of a vehicle equipped with the ECU group 100, can install applications published by third parties into any of the ECUs of the ECU group 100 via a wide-area communication network or the like. Furthermore, the vehicle user can arbitrarily add or modify applications 61 to 64.

In addition, in the case of applications used to provide services that acquire vehicle information from many vehicles and analyze vehicle behavior or driver operation, the service provider, who is the provider of the application, may install the application into any of the ECUs of the ECU group 100 with the permission of the vehicle user. Further, access rights to individual APIs belonging to the API unit 71 from applications installed in the center 35 by service providers or the like may be restricted by the vehicle user for each service provider or application.

### (3-3. Vehicle Service Unit)

The vehicle service unit 7 includes an Application Programming Interface (hereinafter, API) unit 71. In the present embodiment, the first ECU 10 is provided with the API unit 71. The API unit 71 includes a plurality of vehicle APIs. The vehicle APIs are interfaces for accessing subdivided vehicle functions provided to applications 61 to 64 belonging to the service providing unit 6.

The vehicle APIs have standardized syntax that allows requests to be described without dependence on specific vehicle models or grades. When applications 61 to 64 utilize functions provided by the vehicle, they transmit a first command using the vehicle APIs. The first command is a command indicating the information necessary for using the vehicle APIs.

The first command may include a command indicating the request content, instructions such as arguments, function calls, and the like.

The syntax of the vehicle APIs, that is, the format of the first command, is described using generally published, modeled vehicle functions so that it can be created without regard to the vehicle equipment or performance possessed by individual vehicles, similar to applications 61 to 64. In other words, the first command abstractly describes the function to be realized, without specifying vehicle equipment or using expressions dependent on the performance of vehicle equipment. For example, the first command may describe content such as “turn on car finder,” but does not specify which lights among the multiple lights implemented in the vehicle should be illuminated or other specific matters dependent on individual vehicles regarding how to control vehicle equipment.

Upon receiving the first command, the API unit 71 determines, from a formal perspective, whether the first command can be accepted, based on the format of the first command and the access rights possessed by the source of the request. If the API unit 71 determines that the first command can be accepted, it converts the first command into a second command described in a format adapted to the vehicle model and grade of the target vehicle, and transmits it to the state management unit 8. That is, the API unit 71 has a function to convert the first command, described in the standard format handled by the service providing unit 6, into a second command described in a format specific to the vehicle, handled by the state management unit 8 and the equipment management unit 9. The second command is assigned an application ID that identifies the application (hereinafter, requesting application) that was the source of the first command. Furthermore, the API unit 71 has a function to transfer the result notification, which is a response from the state management unit 8 to the second command, to the requesting application.

The API unit 71 includes at least a control API 72 and an information API 73.

The information API 73 is a vehicle API for accepting requests from applications regarding the acquisition of information managed by the state management unit 8.

The control API 72 is a vehicle API for accepting requests from applications regarding the control of equipment managed by the equipment management unit 9.

### (3-4. State Management Unit)

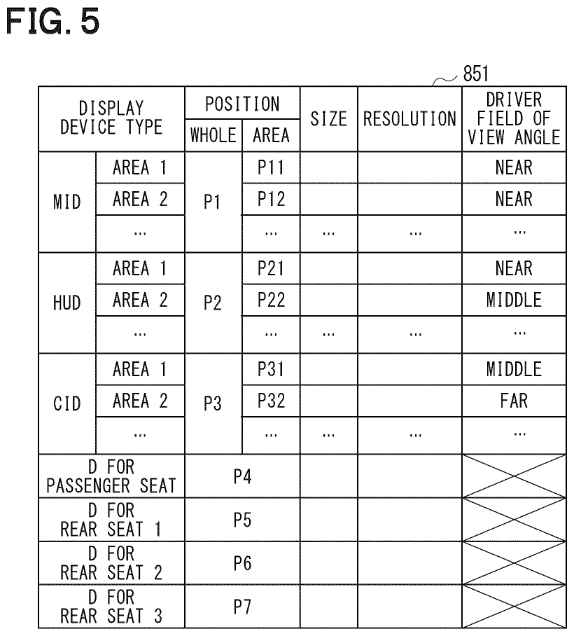

As shown in FIG. 1 and FIG. 4, the state management unit 8 includes a state recognition unit 81, a motion system equipment control unit 82, a Human Machine Interface (hereinafter, HMI) system equipment control unit 83, and a body system equipment control unit 84.

Each of the units 81 to 84 belonging to the state management unit 8 is classified not by implementation means (for example, control units 91 to 99), which are likely to depend on vehicle variations, but by vehicle operations that are likely to be requested by the service providing unit 6. In the present embodiment, each of the units 81 to 84 belonging to the state management unit 8 is provided in any of the first ECU 10 and the third ECUs 20 to the fifth ECU 30 that manage each domain of the vehicle, as shown in FIG. 1.

The state recognition unit 81 corresponds to operations for recognizing the situation of the vehicle itself and its surroundings, such as the position of the vehicle and pedestrians. The state recognition unit 81 targets vehicle equipment belonging to, for example, the camera control unit 91 and the millimeter wave control unit 92. In the present embodiment, the third ECU 20 is provided with the state recognition unit 81.

The motion system equipment control unit 82 corresponds to vehicle operations related to driving, such as turning, moving, and stopping. The motion system equipment control unit 82 targets vehicle equipment belonging to, for example, the brake control unit 93 and the steering control unit 94. In the present embodiment, the first ECU 10 is provided with the motion system equipment control unit 82.

The HMI system equipment control unit 83 corresponds to vehicle operations related to presenting information to the user. The HMI system equipment control unit 83 targets vehicle equipment belonging to, for example, the display control unit 95 and the sound control unit 96. In the present embodiment, the fourth ECU 25 is provided with the HMI system equipment control unit 83. In addition to vehicle equipment belonging to the display control unit 95 and the sound control unit 96, the HMI system equipment control unit 83 may also target vehicle equipment belonging to, for example, a tactile control unit. Vehicle equipment belonging to the tactile control unit may include, for example, equipment for vibrating the steering wheel, equipment for vibrating the seat, and equipment for retracting the seat belt.

The body system equipment control unit 84 corresponds to vehicle operations related to the body system related to the vehicle environment. The body system equipment control unit 84 targets vehicle equipment belonging to, for example, the light control unit 97, the HVAC control unit 98, and the seat control unit 99. In the present embodiment, the fifth ECU 30 is provided with the body system equipment control unit 84.

### (3-5. HMI System Equipment Control Unit)

The HMI system equipment control unit 83 belonging to the state management unit 8 will be described.

As shown in FIG. 4, the HMI system equipment control unit 83 includes an information storage unit 85 and a processing execution unit 86.

The information storage unit 85 stores at least HMI information 851 and restriction information 852.

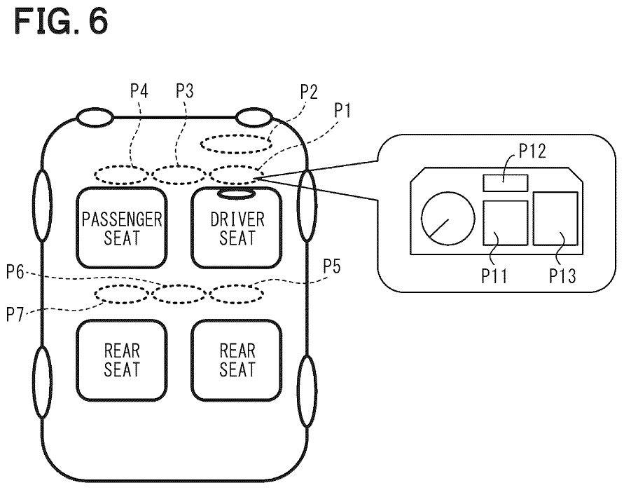

The HMI information 851 stores information regarding HMI system equipment controlled by the HMI system equipment control unit 83. For example, as shown in FIG. 5, information regarding display devices, which are a type of HMI system equipment, is stored for each type of display device, including position, size, resolution, driver viewing angle, and the like.

Types of display devices may include, for example, a Multi-Information Display (hereinafter, MID), a Head-Up Display (hereinafter, HUD), a Center Information Display (hereinafter, CID), a display for the passenger seat (hereinafter, P seat), and displays for multiple rear seats (hereinafter, R seat).

The MID is a display located at position P1 shown in FIG. 6, that is, on the instrument panel directly in front of the driver's seat (hereinafter, D seat). Various information, such as meters and vehicle status, is displayed on the MID. The MID may have multiple display areas. Each display area is arranged at positions P11 to P13 shown in FIG. 6. The HMI information 851 regarding the MID may be set for each of the multiple display areas, including position, size, resolution, driver viewing angle, and the like.

The HUD provides various information to the driver by projecting images onto the front windshield at position P2 shown in FIG. 6, that is, directly in front of the D seat.

The CID is a large display located at position P3 shown in FIG. 6, that is, at the center of the cockpit. The CID mainly displays navigation information, entertainment information, and the like.

The HUD and CID, like the MID, may have multiple display areas. In such cases, the HMI information 851 for the HUD and CID may be set for each of the multiple display areas, including position, size, resolution, driver viewing angle, and the like.

The P seat display is located at position P4 shown in FIG. 6, that is, directly in front of the P seat, and provides various information to the occupant of the P seat.

The R seat displays are located at positions P5 to P7 shown in FIG. 6, that is, directly in front of each of the multiple R seats, and provide various information to the occupants of the R seats.

Not all types of display devices need to be provided, and some may be omitted.

In the HMI information 851, size represents the size of the display area.

Resolution represents the resolution of the display. Driver viewing angle is expressed as “near” when the movement of the driver's gaze to the display area is small with the driver's line of sight facing forward, “far” when the movement is large, and “medium” when the movement is intermediate between “near” and “far.”

The restriction information 852 is information indicating the content of constraints imposed on the HMI when utilizing HMI system equipment, shown for each usage pattern.

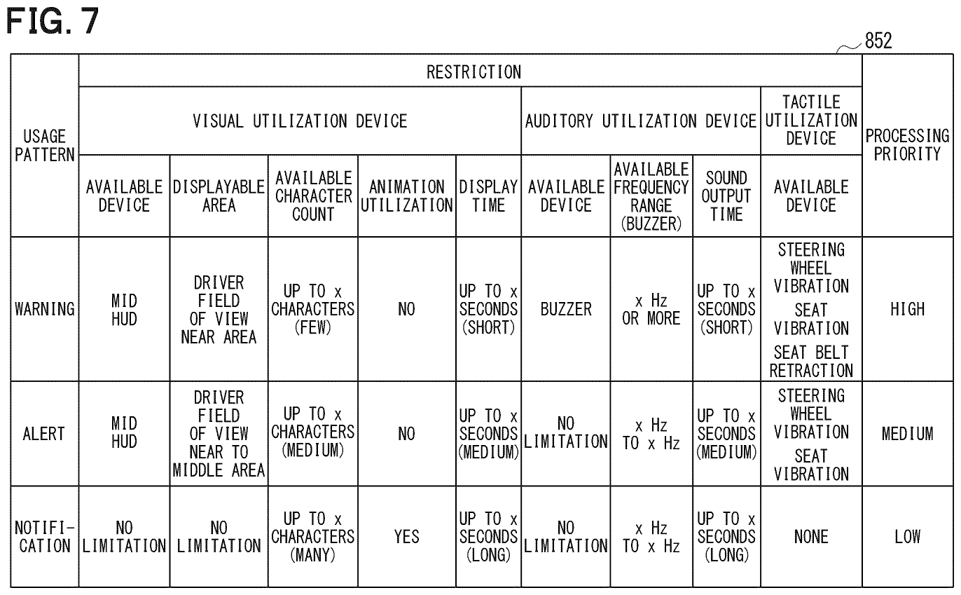

As shown in FIG. 7, usage patterns are classified according to the use or purpose of utilizing HMI system equipment. Usage patterns may include, for example, “warning,” “alert,” and “notification.” Usage patterns are set based on perspectives common to all vehicles, without being limited to specific in-vehicle HMI installed in a vehicle.

The restriction information 852 is set for each of the visual usage devices and auditory usage devices.

The restriction information for visual usage devices may include “available devices,” “displayable areas,” “available character count,” “animation usage,” and “display time.”

“Available devices” is information indicating display devices that can be used in the usage pattern of interest. For example, when the usage pattern is “warning” or “alert,” the MID or HUD may be set as available devices. When the usage pattern is “notification,” there may be no restriction on display devices, and any display device may be set as available.

“Displayable areas” is information indicating which display areas can be used with respect to the driver viewing angle. For example, when the usage pattern is “warning,” display areas with a “near” driver viewing angle are set as displayable areas so that the driver can confirm information with minimal eye movement. When the usage pattern is “alert,” display areas with a “near” to “medium” driver viewing angle are set as displayable areas, allowing greater eye movement than “warning.” When the usage pattern is “notification,” there is no restriction on the driver viewing angle, and any display area may be set as displayable.

“Available character count” indicates the maximum number of characters that can be displayed in the display area. For example, when the usage pattern is “warning,” the count is set low enough for the driver to recognize instantly. When the usage pattern is “notification,” there is no particular restriction, so the count is set to a high value. When the usage pattern is “alert,” it may be set to an intermediate value.

“Animation usage” indicates whether or not animation can be used in the display area. For example, when the usage pattern is “warning” or “alert,” animation usage may be set to “not allowed”. When the usage pattern is “notification,” animation usage may be set to “allowed”.

“Display time” represents the duration for which the display is maintained. For example, when the usage pattern is “warning,” the display time is set to a short duration. When the usage pattern is “notification,” the display time is set to a long duration. When the usage pattern is “alert,” it may be set to an intermediate duration.

The restriction information for auditory usage devices may include “available devices,” “available frequency range,” and “sound output time.”

“Available devices” refers to information indicating which sound devices can be used for the relevant usage pattern. For example, when the usage pattern is “warning,” a buzzer that can reliably attract the driver's attention may be set as an available device. When the usage pattern is “alert” or “notification,” there may be no restriction on sound devices, and any sound device, including devices for voice output, may be set as available.

“Available frequency range” is information indicating the pitch range of the buzzer sound that can be used. For example, when the usage pattern is “warning,” the frequency range may be set to a high pitch that is easy to hear. When the usage pattern is “alert” or “notification,” the frequency range may be set to a lower pitch so that it can be distinguished from “warning”.

“Sound output time” is information indicating the maximum duration of the sound output duration in the usage pattern. For example, when the usage pattern is “warning,” the output time may be set to a “short” duration due to urgency. When the usage pattern is “alert,” the output time may be set to a “medium” duration to allow notification by voice. When the usage pattern is “notification,” the output time may be set to a “long” duration to sufficiently convey the necessary information.

In addition to “visual usage devices” and “auditory usage devices,” the restriction information may include restriction information regarding “tactile usage devices.”

The restriction information for “tactile usage devices” may include “available devices.” “Available devices” is information indicating which vibration devices can be used for the relevant usage pattern. For example, when the usage pattern is “warning,” a steering wheel vibration device, seat vibration device, and seat belt retraction device may be set to available as “available devices”. When the usage pattern is “alert,” a steering wheel vibration device and seat vibration device may be set as available. When the usage pattern is “notification,” tactile usage devices may be set as “not available”.

Here, only “available devices” is exemplified as restriction information for “tactile usage devices,” but “vibration time,” “vibration intensity,” “vibration pattern,” and the like may also be included in the restriction information.

Any one, any two, or all three of “visual usage devices,” “auditory usage devices,” and “tactile usage devices” may be used, either individually or in combination.

Each usage pattern is associated with a “priority.” The “priority” of a usage pattern represents the processing priority when HMI usage requests conflict. When the usage pattern is “warning,” the priority may be set to “high”. When the usage pattern is “alert,” the priority may be set to “medium”. When the usage pattern is “notification,” the priority may be set to “low.”

The HMI information 851 and restriction information 852 vary for each vehicle depending on the performance and arrangement of the HMI system equipment installed in the vehicle. The HMI information 851 and restriction information 852 stored in the information storage unit 85 may be acquired from the center 35 outside the vehicle or the like. Part of the HMI information 851 stored in the information storage unit 85 may be acquired from the equipment management unit 9.

Returning to FIG. 4, the processing execution unit 86, upon receiving a request (i.e., the second command) from the vehicle service unit 7, determines whether the state of the vehicle is suitable for executing the second command, and, if suitable, instructs the equipment management unit 9 to operate the target equipment.

The processing execution unit 86 outputs operation instructions for the target equipment to the equipment management unit 9 and has a function to provide the operation result returned from the equipment management unit 9 to the vehicle service unit 7 as a result notification for the second command.

The processing execution unit 86 includes an HMI information providing unit 861 and an HMI output control unit 862.

The HMI information providing unit 861 executes information providing processing. The information providing processing is executed when the information API 73 receives an HMI information acquisition request (i.e., the first command) from an application belonging to the service providing unit 6, and when the HMI system equipment control unit 83 receives the HMI information acquisition request (i.e., the second command) transferred from the vehicle service unit 7. In the information providing processing, the HMI information 851 and restriction information 852 stored in the information storage unit 85 are provided to the requesting application.

The HMI output control unit 862 executes HMI arbitration processing. The HMI arbitration processing is executed when the control API 72 receives an HMI control request (i.e., the first command) from an application belonging to the service providing unit 6, and when the HMI system equipment control unit 83 receives the HMI control request (i.e., the second command) transferred from the vehicle service unit 7.

The HMI information acquisition request includes at least information for identifying the requesting application.

The HMI control request includes, in addition to information for identifying the requesting application, information specifying which HMI system device is to be used and in what manner. The requesting application is required to set the usage mode described in the HMI control request so as to satisfy one of the usage patterns in the restriction information 852 shown in FIG. 7.

### 4. Processing

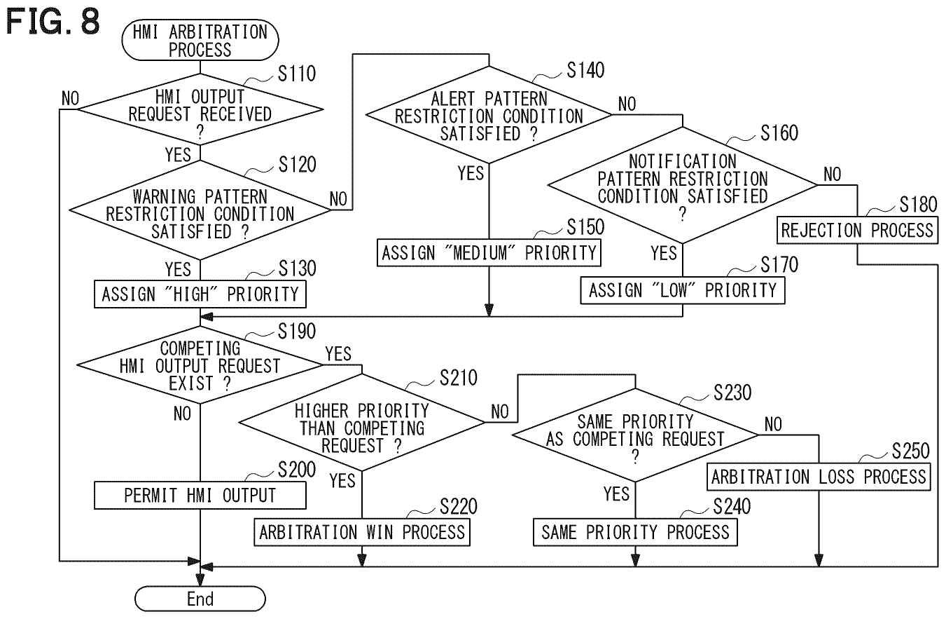

The HMI arbitration processing executed by the HMI output control unit 862 will be described with reference to the flowchart in FIG. 8. The HMI arbitration processing is repeatedly executed after the fourth ECU 25, which is equipped with the HMI system equipment control unit 83, is activated.

When the HMI arbitration processing is started, in S110, the HMI output control unit 862 determines, via the control API 72, whether an HMI usage request has been received from the vehicle service unit 7. If the HMI output control unit 862 has received an HMI usage request, the process proceeds to S120; if not, the process ends. Hereinafter, the received HMI usage request is referred to as the acceptance request.

In S120, the HMI output control unit 862 determines whether the usage mode indicated in the acceptance request satisfies the constraint conditions of the usage pattern “warning.” If it is determined that the constraint conditions of the usage pattern “warning” are satisfied, the process proceeds to S130; if not, the process proceeds to S140.

In S130, the HMI output control unit 862 sets the priority of the acceptance request to “high” and proceeds to S190.

In S140, the HMI output control unit 862 determines whether the usage mode indicated in the acceptance request satisfies the constraint conditions of the usage pattern “alert.” If it is determined that the constraint conditions of the usage pattern “alert” are satisfied, the process proceeds to S150; if not, the process proceeds to S160.

In S150, the HMI output control unit 862 sets the priority of the acceptance request to “medium” and proceeds to S190.

In S160, the HMI output control unit 862 determines whether the usage mode indicated in the acceptance request satisfies the constraint conditions of the usage pattern “notification.” If it is determined that the constraint conditions of the usage pattern “notification” are satisfied, the process proceeds to S170; if not, the process proceeds to S180.

In S170, the HMI output control unit 862 sets the priority of the acceptance request to “low” and proceeds to S190.

In S180, the HMI output control unit 862 executes rejection processing to reject the acceptance request and ends the process. In the rejection processing, a result notification indicating that the request has been rejected is sent to the requesting application of the acceptance request. The requesting application may output an HMI usage request again upon receiving the rejection notification.

In S190, the HMI output control unit 862 determines whether there is a conflicting HMI usage request (hereinafter, conflicting request) with the acceptance request. If there is a conflicting request, the process proceeds to S210. If there is no conflicting request, the process proceeds to S200.

In S200, the HMI output control unit 862 performs output execution processing to execute HMI output according to the acceptance request, and ends the HMI arbitration processing. In the output execution processing, an instruction is output to the equipment management unit 9, which manages the HMI system equipment indicated in the acceptance request, to perform output in the usage mode indicated in the acceptance request. Further, if a response is received from the equipment management unit 9, a result notification indicating the response content is returned to the requesting application via the vehicle service unit 7.

In S210, the HMI output control unit 862 determines whether the acceptance request has a higher priority than the conflicting request. If the acceptance request has a higher priority, the process proceeds to S220. If the acceptance request has not a higher priority, the process proceeds to S230.

In S220, the HMI output control unit 862 executes arbitration win processing. In the arbitration win processing, the HMI output control based on the conflicting request is interrupted or forcibly terminated, and then the HMI output control based on the acceptance request is executed. If the conflicting request is forcibly terminated, a result notification indicating that the HMI output control based on the conflicting request has been forcibly terminated is sent to the requesting application of the conflicting request. If the conflicting request is interrupted, after the HMI output control based on the acceptance request is completed, the interrupted HMI output control based on the conflicting request is resumed, and the HMI arbitration processing ends.

In S230, the HMI output control unit 862 determines whether the acceptance request and the conflicting request have the same priority. If they have the same priority, the process proceeds to S240; if not, that is, if the acceptance request has a lower priority than the conflicting request, the process proceeds to S250.

In S240, the HMI output control unit 862 executes same priority processing and ends the HMI arbitration processing. In the same priority processing, the acceptance request may be rejected, and the HMI output control based on the conflicting request may be continued. In this case, a result notification indicating that the HMI usage request has been rejected is output to the requesting application of the acceptance request. Alternatively, in the same priority processing, the acceptance request may be put on standby, and after the HMI output control based on the conflicting request is completed, the HMI output control based on the acceptance request may be executed. Alternatively, in the same priority processing, the HMI output control based on the conflicting request may be interrupted, the HMI output control based on the acceptance request may be executed, and after the HMI control based on the acceptance request is completed, the interrupted HMI output control based on the conflicting request may be resumed. Alternatively, in the same priority processing, the HMI output control based on the conflicting request may be forcibly terminated, and the HMI output control based on the acceptance request may be executed. In this case, a result notification indicating that the HMI output control based on the conflicting request has been forcibly terminated may be returned to the requesting application of the conflicting request.

In S250, the HMI output control unit 862 executes arbitration loss processing and ends the HMI arbitration processing. In the arbitration loss processing, the acceptance request is rejected, and the HMI output control based on the conflicting request is continued. Further, a result notification indicating that the HMI usage request has been rejected is output to the requesting application of the acceptance request.

### 5. Operation

### (5-1. Basic Operation)

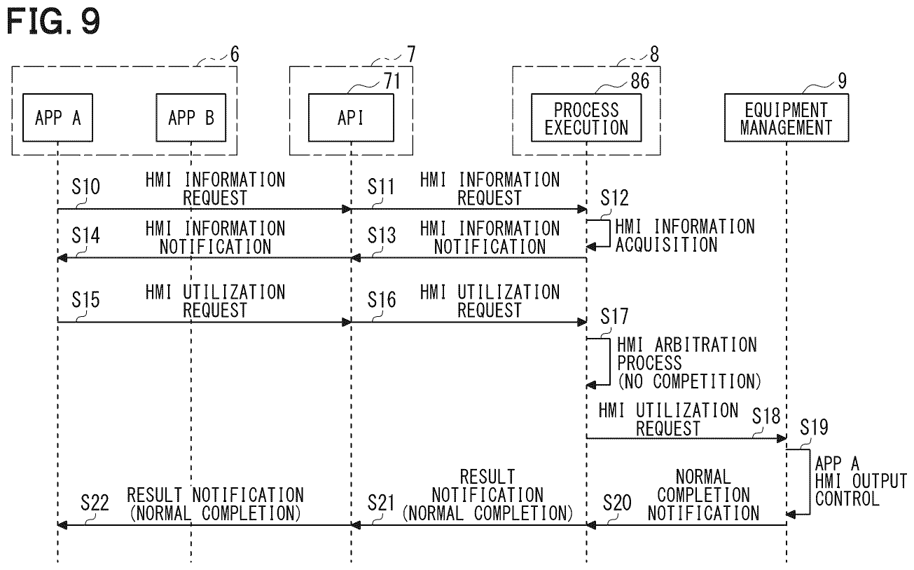

Next, the basic operation of the vehicle control system 1 will be described with reference to the sequence diagram in FIG. 9.

As shown in FIG. 9, in S10, application A belonging to the service providing unit 6 uses the information API 73 of the API unit 71 of the vehicle service unit 7 to transmit an “HMI information request” in the format of the first command.

The API unit 71 performs a format check and authority check on the received “HMI information request,” and if both are determined to be compliant, converts the “HMI information request” from the format of the first command to the format of the second command. Then, in S11, the API unit 71 transmits the “HMI information request,” converted to the format of the second command, to the processing execution unit 86 of the HMI system equipment control unit 83 belonging to the state management unit 8.

Upon receiving the “HMI information request,” the processing execution unit 86 acquires the HMI information 851 and restriction information 852 from the information storage unit 85 in S12. Furthermore, in S13, the processing execution unit 86 transmits an “HMI information notification” indicating the acquired HMI information 851 and restriction information 852 to the API unit 71.

In S14, the API unit 71 transmits the “HMI information notification” received from the processing execution unit 86 to application A, which is the requesting application of the “HMI information request”.

Application A, in consideration of the HMI information 851 and restriction information 852 indicated in the “HMI information notification,” sets the content of the “HMI usage request,” that is, the HMI system equipment to be used and the usage mode. For example, the “HMI usage request” may specify content such as “display the characters ‘xxxx’ for ‘x seconds’ in the display area set to ‘near’ driver viewing angle of ‘MID’”.

In S15, application A uses the control API 72 of the API unit 71 to transmit an “HMI usage request” in the format of the first command.

Upon receiving the “HMI usage request,” the API unit 71 performs a format check and authority check in S16, as in the case of the “HMI information request.” If the check result is compliant, the “HMI usage request” is converted from the format of the first command to the format of the second command and transmitted to the processing execution unit 86.

Upon receiving the “HMI usage request,” the processing execution unit 86 executes HMI arbitration processing in S17. If it is determined as a result of the HMI arbitration processing that there is no conflicting HMI usage request, the processing execution unit 86 transmits the “HMI usage request” to the equipment management unit 9 in S18.

In S19, the equipment management unit 9 executes HMI output control in accordance with the received “HMI usage request.” Upon completion of the HMI output control, the equipment management unit 9 notifies the processing execution unit 86 in S20 that the HMI output control has been completed normally.

In S21, the processing execution unit 86 transmits a “result notification” indicating the notification content from the equipment management unit 9 to the API unit 71.

In S22, the API unit 71 transmits the “result notification” received from the processing execution unit 86 to application A, which is the requesting application of the “HMI usage request.”

### (5-2. Operation When HMI Usage Requests Conflict 1)

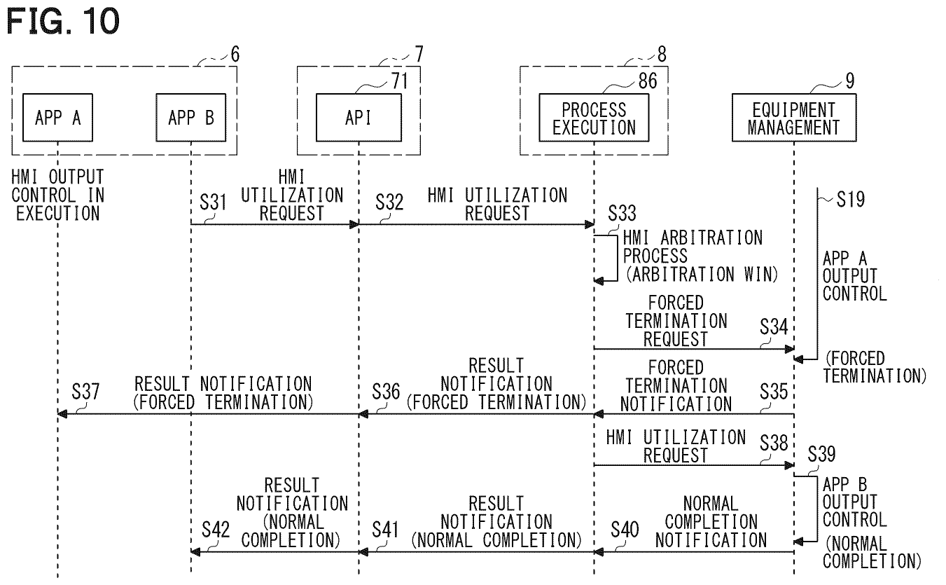

With reference to FIG. 10, the operation in the case where HMI usage requests conflict during HMI arbitration processing will be described. Here, it is assumed that while HMI output control based on an HMI usage request from application A is being executed, an HMI usage request from application B occurs. That is, the HMI usage request from application A is the conflicting request, and the HMI usage request from application B is the acceptance request.

Although omitted from the description, it is assumed that application B, like application A, has acquired the HMI information 851 and restriction information 852 via an “HMI information request.”

As shown in FIG. 10, in S31, application B transmits an “HMI usage request” in the format of the first command, as in the case of S15.

Upon receiving the “HMI usage request,” the API unit 71, in S32, converts the “HMI usage request” from the format of the first command to the format of the second command, as in the case of S16, and transmits it to the processing execution unit 86.

Upon receiving the “HMI usage request,” the processing execution unit 86 executes HMI arbitration processing in S33. If, as a result of the HMI arbitration processing, there is a conflicting HMI usage request and it is determined that arbitration is won, the processing execution unit 86 transmits a “forced termination request” to the equipment management unit 9 in S34.

Upon receiving the “forced termination request,” the equipment management unit 9 forcibly terminates the HMI output control based on the conflicting request being executed, and in S35, notifies the processing execution unit 86 that forced termination has been completed.

Upon receiving the notification from the equipment management unit 9, the processing execution unit 86 transmits a “result notification” indicating the notification content to the API unit 71 in S36, and in S38, transmits the “HMI usage request” from application B, which is the acceptance request, to the equipment management unit 9.

In S37, the API unit 71 transmits the “result notification” received from the processing execution unit 86 to application A, which is the requesting application of the conflicting request.

In S39, the equipment management unit 9 executes HMI output control in accordance with the received “HMI usage request.” Upon completion of the HMI output control, the equipment management unit 9 notifies the processing execution unit 86 in S40 that the HMI output control has been completed normally.

In S41, the processing execution unit 86 transmits a “result notification” indicating the notification content from the equipment management unit 9 to the API unit 71.

In S42, the API unit 71 transmits the “result notification” received from the processing execution unit 86 to application B, which is the requesting application of the acceptance request.

That is, when the acceptance request wins arbitration over the conflicting request, the HMI output control based on the conflicting request may be forcibly terminated, and the HMI output control based on the acceptance request may be executed.

### (5-3. Operation When HMI Usage Requests Conflict 2)

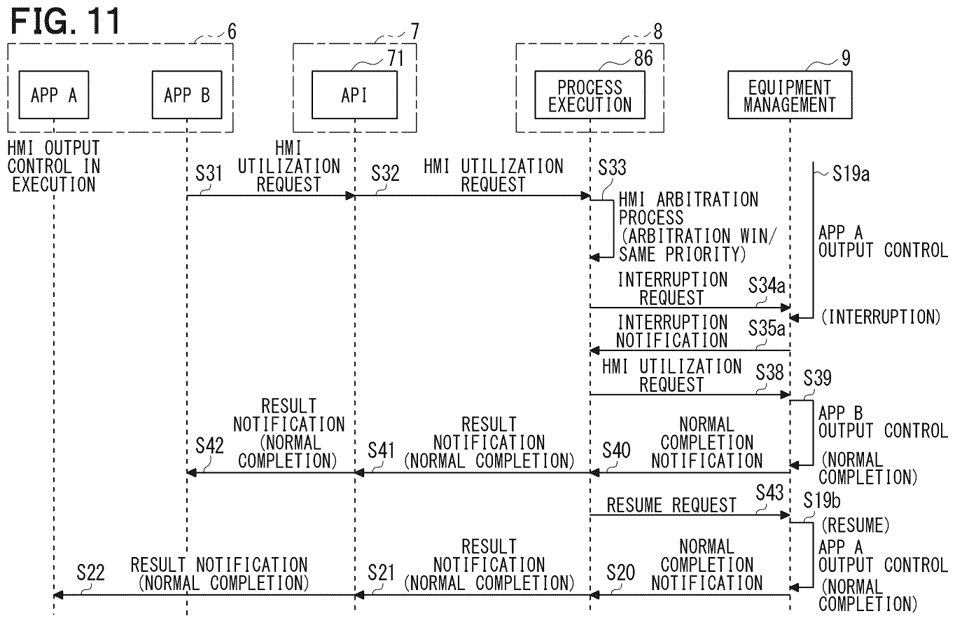

With reference to FIG. 11, another operation in the case where HMI usage requests conflict during HMI arbitration processing will be described.

As shown in FIG. 11, S31 to S33 are the same as described in FIG. 10. However, in the HMI arbitration processing of S33, the processing execution unit 86 determines either that the acceptance request has won arbitration over the conflicting request, or that the acceptance request and the conflicting request have the same priority. In this case, in S34a, the processing execution unit 86 transmits an “interruption request” to the equipment management unit 9.

Upon receiving the “interruption request,” the equipment management unit 9 interrupts the HMI output control based on the conflicting request being executed, and in S35a, notifies the processing execution unit 86 that the HMI output control has been interrupted.

Upon receiving the notification from the equipment management unit 9, the processing execution unit 86 transmits the “HMI usage request” from application B, which is the acceptance request, to the equipment management unit 9 in S38.

In S39, the equipment management unit 9 executes HMI output control in accordance with the received “HMI usage request.” After the HMI output control is completed, the equipment management unit 9 notifies the processing execution unit 86 in S40 that the HMI output control has been completed normally.

Upon receiving the notification from the equipment management unit 9, the processing execution unit 86 transmits a “result notification” indicating the notification content from the equipment management unit 9 to the API unit 71 in S41. Furthermore, in S43, the processing execution unit 86 transmits a “resume request” for the previously interrupted HMI output control based on the conflicting request to the equipment management unit 9.

In S42, the API unit 71 transmits the “result notification” received from the processing execution unit 86 to application B, which is the requesting application of the acceptance request.

Upon receiving the “resume request” from the processing execution unit 86, the equipment management unit 9 resumes the HMI output control based on the conflicting request in S19b. After the HMI output control is completed, the equipment management unit 9 notifies the processing execution unit 86 in S20 that the HMI output control has been completed normally.

In S21, the processing execution unit 86 transmits a “result notification” indicating the notification content from the equipment management unit 9 to the API unit 71.

In S22, the API unit 71 transmits the “result notification” received from the processing execution unit 86 to application A, which is the requesting application of the HMI usage request.

That is, when the acceptance request wins arbitration over the conflicting request, or when the acceptance request and the conflicting request have the same priority, the HMI output control based on the conflicting request may be interrupted, and the HMI output control based on the acceptance request may be executed. After the execution of the HMI output control based on the acceptance request, the interrupted HMI output control based on the conflicting request may be resumed.

### (5-4. Operation When HMI Usage Requests Conflict 3)

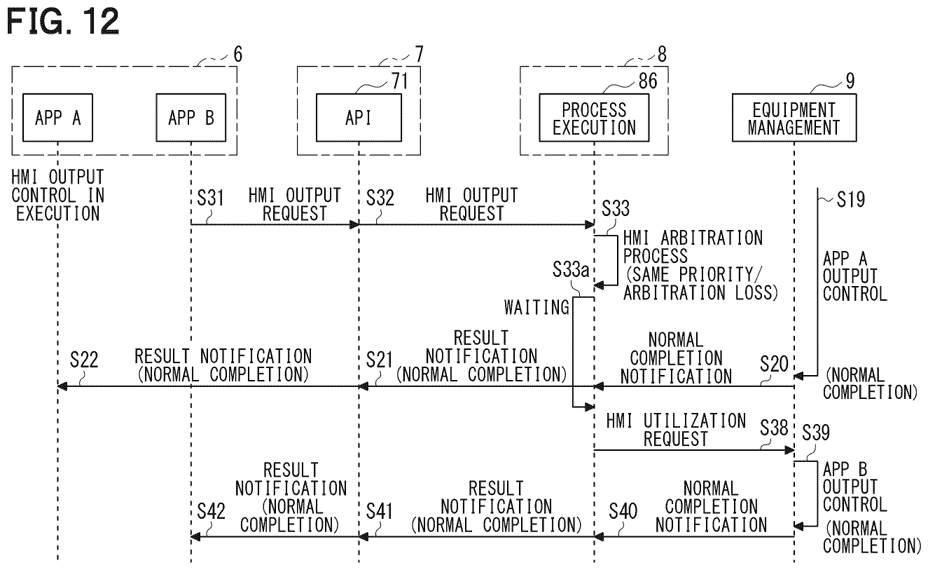

With reference to FIG. 12, another operation in the case where HMI usage requests conflict during HMI arbitration processing will be described.

As shown in FIG. 12, S31 to S33 are the same as described in FIG. 10. However, in the HMI arbitration processing of S33, the processing execution unit 86 determines either that the acceptance request and the conflicting request have the same priority, or that the acceptance request has lost arbitration to the conflicting request. In this case, in S33a, the processing execution unit 86 waits until it receives a notification from the equipment management unit 9 indicating that the HMI output control based on the conflicting request has been completed normally.

When the HMI output control based on the conflicting request is completed, the equipment management unit 9 notifies the processing execution unit 86 in S20 that the HMI output control has been completed normally.

Upon receiving the notification from the equipment management unit 9, the processing execution unit 86 transmits a “result notification” indicating the notification content from the equipment management unit 9 to the API unit 71 in S21. Furthermore, the processing execution unit 86 releases the standby state of the acceptance request and, in S38, transmits the acceptance request (i.e., “HMI usage request” ) to the equipment management unit 9.

In S22, the API unit 71 transmits the “result notification” received from the processing execution unit 86 to application A, which is the requesting application of the “HMI usage request.”

In S39, the equipment management unit 9 executes HMI output control in accordance with the received “HMI usage request.” After the HMI output control is completed, the equipment management unit 9 notifies the processing execution unit 86 in S40 that the HMI output control has been completed normally.

Upon receiving the notification from the equipment management unit 9, the processing execution unit 86 transmits a “result notification” indicating the notification content from the equipment management unit 9 to the API unit 71 in S41.

In S42, the API unit 71 transmits the “result notification” received from the processing execution unit 86 to application B, which is the requesting application of the acceptance request.

That is, when the acceptance request and the conflicting request have the same priority, or when the acceptance request loses arbitration to the conflicting request, the system may wait for the completion of the HMI output control based on the conflicting request before executing the HMI output control based on the acceptance request.

### (5-5. Operation When HMI Usage Requests Conflict 4)

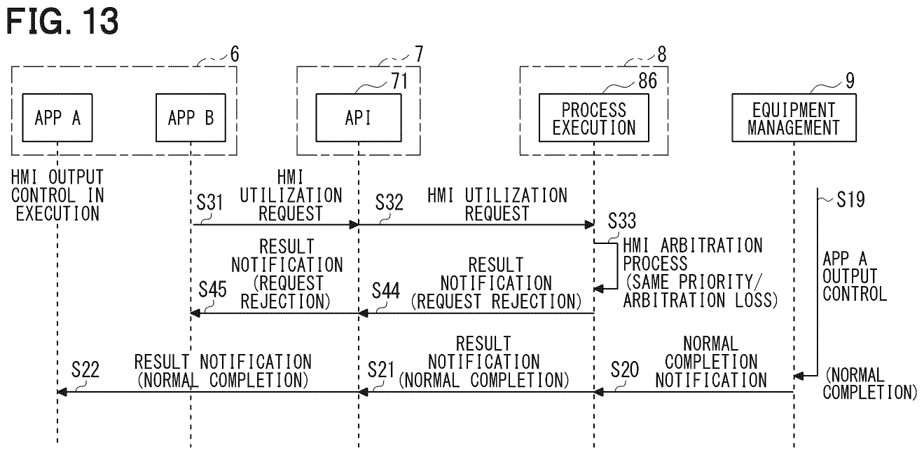

With reference to FIG. 13, another operation in the case where HMI usage requests conflict during HMI arbitration processing will be described.

As shown in FIG. 13, S31 to S33 are the same as described in FIG. 10. However, in the HMI arbitration processing of S33, the processing execution unit 86 determines either that the acceptance request and the conflicting request have the same priority, or that the acceptance request has lost arbitration to the conflicting request. In this case, the processing execution unit 86 rejects the acceptance request and, in S44, transmits a “result notification” indicating the rejection to the API unit 71.

In S45, the API unit 71 transmits the “result notification” received from the processing execution unit 86 to application B, which is the requesting application of the acceptance request.

When the HMI output control based on the conflicting request is completed, the equipment management unit 9 notifies the processing execution unit 86 in S20 that the HMI output control has been completed normally.

Upon receiving the notification from the equipment management unit 9, the processing execution unit 86 transmits a “result notification” indicating the notification content from the equipment management unit 9 to the API unit 71 in S21.

In S22, the API unit 71 transmits the “result notification” received from the processing execution unit 86 to application A, which is the requesting application of the conflicting request.

That is, when the acceptance request and the conflicting request have the same priority, or when the acceptance request loses arbitration to the conflicting request, the acceptance request may be rejected. The requesting application, application B, which receives the rejection notification in the “result notification,” may re-request the rejected “HMI usage request.”

### 6. Correspondence of Terms

In the present embodiment, the HMI information providing unit 861 corresponds to the information providing unit disclosed herein, and the HMI output control unit 862 corresponds to the output control unit disclosed herein. Among the restriction information in the present embodiment, “available devices” and “displayable areas” correspond to information relating to the noticeability of the driver with respect to HMI output as disclosed herein, and to information specifying the occupant of the vehicle to whom the information is to be provided. Among the restriction information in the present embodiment, “available character count” corresponds to the amount of information that can be provided as disclosed herein, and “display time” and “sound output time” correspond to the available time for providing information as disclosed herein.

### 7. Effects

According to the first embodiment described in detail above, the following effects are achieved, for example.

(7a) The HMI system equipment control unit 83 determines which usage pattern the usage mode indicated in the HMI usage request corresponds to, and arbitrates conflicting HMI usage requests using the priority associated with the usage pattern. Therefore, the HMI system equipment control unit 83 can perform arbitration of HMI usage requests without grasping the content of HMI notifications and without using a priority table that associates notification content with priority. As a result, compared to conventional technology that uses a priority table, the labor of rewriting the priority table each time an application is added can be omitted.

(7b) The HMI system equipment control unit 83 provides, in response to HMI information requests from applications, HMI information indicating what kind of in-vehicle HMI is arranged where, and restriction information representing restrictions on the use of in-vehicle HMI. Therefore, applications can generate appropriate HMI usage requests according to the in-vehicle HMI possessed by the vehicle, based on the acquired HMI information and restriction information. In other words, the same application can be applied to a wide variety of vehicles equipped with different in-vehicle HMIs.

### 8. Other Embodiments

The embodiments of the present disclosure have been described above, but the present disclosure is not limited to the above embodiments and may be implemented in various modified forms.

(8a) In the above embodiment, the priority among HMI usage requests is determined according to the usage pattern, and when the same priority is assigned, no further priority determination is performed. However, the priority among HMI usage requests using the same usage pattern may be determined using application attribute information. Application attribute information refers to information regarding the manufacturer of the requesting application for the HMI usage request, and information such as the charge amount for the use of vehicle resources (for example, vehicle APIs) by the application, which can be used without knowing the content of the application or the notification content via the in-vehicle HMI. In this case, for example, the priority may be set according to whether the manufacturer of the requesting application is a vehicle manufacturer, a supplier, or a third party. A third party refers to a manufacturer other than a vehicle manufacturer or supplier, such as an application manufacturer. Specifically, the vehicle manufacturer may be given higher priority than the supplier and third party. Alternatively, the priority order may be set as vehicle manufacturer≥supplier>third party.

(8b) The restriction information provided by the HMI information providing unit 861 in response to an HMI information request may include dynamic information that changes according to the state of the vehicle or the occurrence status of conflicts in HMI usage requests. The state of the vehicle may include, for example, parking, stopping, driving, etc. For example, among the restriction information, “available character count,” “animation usage,” “display time,” and “available devices” may be treated as dynamic information. Specifically, in the case of parking, since it is safe, the “available character count” for display in areas with a near viewing angle may be increased, or “animation usage” may be permitted. Further, in situations where many conflicts in HMI usage requests occur, in order to reduce user load, “display time” may be shortened, “available character count” may be reduced, or “available devices” may be limited to auditory usage devices or tactile usage devices. Furthermore, for notifications with no urgency, such as weather information, a constraint permitting output at a later time may be added.

(8c) In the above embodiment, the HMI targeted by the HMI usage request is not limited to in-vehicle HMI installed in the vehicle, and may include portable devices such as smartphones or tablets possessed by the vehicle owner or occupants.

(8d) Each ECU belonging to the ECU group 100 described in the present disclosure, the center 35, and their methods may be implemented by a dedicated computer including a processor and memory programmed to execute one or more functions embodied as a computer program. Alternatively, each ECU belonging to the ECU group 100, the center 35, and their methods may be implemented by a dedicated computer provided by configuring the processor with one or more dedicated hardware logic circuits. Alternatively, each ECU belonging to the ECU group 100, the center 35, and their methods may be implemented by one or more dedicated computers configured by a combination of a processor and memory programmed to execute one or more functions and a processor configured with one or more hardware logic circuits. Further, the computer program may be stored as instructions executable by a computer on a computer-readable, non-transitory tangible recording medium. The method for realizing the functions of each unit included in each ECU and the center 35 belonging to the ECU group 100 does not necessarily have to include software, and all functions may be realized using one or more hardware components.

(8e) The multiple functions possessed by one component in the above embodiment may be realized by multiple components, or one function possessed by one component may be realized by multiple components. Further, multiple functions possessed by multiple components may be realized by one component, or one function realized by multiple components may be realized by one component. Also, part of the configuration of the above embodiment may be omitted. At least part of the configuration of the above embodiment may be added to or replaced with the configuration of another embodiment described above.

(8f) In addition to the vehicle control system described above, the present disclosure may be realized in various forms, such as a system including the vehicle control system as a component, a program for causing a computer to function as the vehicle control system, a non-transitory tangible recording medium such as a semiconductor memory on which the program is recorded, and an arbitration method for HMI usage requests.

What is claimed is:

1. A vehicle control system comprising:
at least one of (i) a circuit and (ii) a processor with a memory storing computer program code executable by the processor, the at least one of the circuit and the processor configured to cause the vehicle control system to:
provide, in response to a request from application software, restriction information set for each usage pattern classified according to use or purpose of utilizing an HMI for a vehicle, the restriction information including an HMI available in the usage pattern and constraints imposed on the HMI in the usage pattern, to application software that is a source of the request; and
control the HMI in accordance with an HMI usage request from the application software requesting use of the HMI,
wherein
the at least one of the circuit and the processor is configured to determine to which usage pattern a content of the HMI usage request corresponds, and, when HMI usage requests conflict, to arbitrate conflicting HMI usage requests according to a priority associated with each usage pattern.

2. The vehicle control system according to claim 1, wherein
the at least one of the circuit and the processor is further configured to store the restriction information,
wherein
the at least one of the circuit and the processor is configured to provide the restriction information stored.

3. The vehicle control system according to claim 1, wherein
the at least one of the circuit and the processor is configured to reject the HMI usage request when the content of the HMI usage request does not correspond to any one of usage patterns.

4. The vehicle control system according to claim 1, wherein
the restriction information provided includes dynamic information that changes according to a state of the vehicle equipped with the vehicle control system or according to an occurrence status of conflicts in the HMI usage requests.

5. The vehicle control system according to claim 1, wherein
the restriction information provided includes at least one of: information indicating an available in-vehicle HMI, information corresponding to a noticeability of a driver with respect to output, information amount that can be provided, available duration for providing information, and information specifying an occupant of the vehicle to whom the information is to be provided.

6. The vehicle control system according to claim 1, wherein
when usage patterns of the conflicting HMI usage requests are identical, the at least one of the circuit and the processor is configured to arbitrate output according to application attribute information regarding the application software that is a source of the HMI usage request, and
the application attribute information includes at least one of: information regarding a manufacturer of the application software, and amount charged for use of vehicle resources by the application software.

7. An arbitration method in which a computer installed in a vehicle arbitrates HMI usage requests from a plurality of application software utilizing HMI for the vehicle, the arbitration method comprising:
determining which usage pattern, classified according to use or purpose of utilizing the HMI, a content of the HMI usage request corresponds to; and
when the HMI usage requests conflict, arbitrating conflicting HMI usage requests according to a priority associated with each usage pattern.

8. A non-transitory computer readable storage medium storing a program for causing a computer to function as:
an information providing unit configured to provide, in response to a request from application software, restriction information set for each usage pattern classified according to use or purpose of utilizing an HMI for a vehicle, the restriction information including an HMI available in the usage pattern and constraints imposed on the HMI in the usage pattern, to application software that is a source of the request; and
an output control unit configured to control the HMI in accordance with an HMI usage request from the application software requesting use of the HMI,
wherein
the output control unit is configured to determine to which usage pattern a content of the HMI usage request corresponds, and, when HMI usage requests conflict, to arbitrate conflicting HMI usage requests according to a priority associated with each usage pattern.

9. A vehicle control system comprising:
application software; and
at least one of (i) a circuit and (ii) a processor with a memory storing computer program code executable by the processor, the at least one of the circuit and the processor configured to cause the vehicle control system to:
provide, in response to a request from the application software, restriction information set for each usage pattern classified according to use or purpose of utilizing an HMI for a vehicle, the restriction information including an HMI available in the usage pattern and constraints imposed on the HMI in the usage pattern, to the application software; and
control the HMI in accordance with an HMI usage request from the application software,
wherein
the at least one of the circuit and the processor is configured to determine to which usage pattern a content of the HMI usage request corresponds, and, when HMI usage requests conflict, to arbitrate conflicting HMI usage requests according to a priority associated with each usage pattern, and
the application software is configured to set the content of the HMI usage request in consideration of the restriction information acquired.
